(19) United States
(12) Patent Application Publication
(10) Pub. No.: US 2005/0023781 A1
(43) Pub. Date: Feb. 3, 2005

(54) Universal attachment structure

(76) Inventor: Charles M. Ortega, Palos Verdes Estates, CA (US)

Correspondence Address: Susan Yee;CARR & FERRELL, Suite 200, 2225 East Bayshore Road, Palo Alto, CA, 94303, US

(21) Appl. No.: 10/631,214

(22) Filed: Jul. 31, 2003

(51) Int. Cl. B62B 1/00

(52) U.S. Cl. 280/47.24

(57) ABSTRACT

A universal attachment structure is provided for transporting an item, such as a golf bag. One or more wheels are coupled to a base section. One or more telescoping arms extend upward from the base section. At least one adjustable loop is coupled to the telescoping arms. A handle is coupled to the attachment fixtures.

### BACKGROUND OF THE INVENTION

### FIELD OF THE INVENTION

(00011 The present invention relates generally to the field of golf products, and more particularly to a universal attachment structure for securing an item, such as a golf bag.

### BACKGROUND OF THE INVENTION

The game of golf traditionally requires that numerous items and paraphernalia associated with the game be transported around the golf course. Generally, the items are transported via a golf bag. Golf bags accordingly encase not only clubs, but often shoes, golf balls, golf gloves, score cards, pens and pencils, cell phones, and a plurality of other items that a golfer desires to keep close at hand during the game.

This assortment of paraphernalia can add considerable weight to what is already a fairly heavy golf bag. Due to the weight of a golf bag, most golf courses provide motorized golf carts for transport. Motorized golf carts include straps on the back for attaching the golf bag. The golf carts are maneuvered on the pathways provided therefore, as well as some sections of the course itself. However, golf carts are not allowed on the putting green and other areas of the golf course. Thus, the golfer is forced to unstrap his/her bag and carry it across the fairway, side of the putting green, etc. in order to have access to a variety of clubs. Otherwise, the golfer can select one or two clubs he/she thinks he/she might use in the areas inaccessible by the golf cart. In this latter case, the golfer often lacks the ideal club for the occasion. The former case necessitates a delay in play due to the golfer unstrapping the golf bag, carrying it to the next point of play, returning to the golf cart, strapping the bag back onto the golf cart, etc. Further, the sheer weight of the golf bag may result in a delay in play since it tends to slow a golfer carrying the bag.

As an alternative, golf courses frequently offer wheeled golf carts for transporting golf bags. Wheeled golf carts include equipment for attaching a golf bag and typically include a handle for pulling the cart via wheels extending from legs attached to the cart. Many golfers prefer wheeled golf carts since walking the golf course during the golfer's round facilitates a cardiovascular workout. These manual golf carts, however, are often bulky and clumsy. In addition, due to the cardiovascular benefits, some golfers prefer to carry their golf bag for some portion of the round. Since the manual cart cannot be left and is far too heavy and awkward to carry, this option is eliminated.

Therefore, it can be appreciated that there exists a continuing need for a universal golf bag attachment that does not interfere with carrying the bag or transporting the bag onto various areas of the golf course, as well as features that do not add considerable weight to the golf bag.

### SUMMARY OF THE INVENTION

The present invention provides in various embodiments a universal attachment structure. A base section has affixed to it one or more wheels. Telescoping arms having a top section and a bottom section extend upward from the base section. Attachment fixtures are coupled to the telescoping arms. A handle is coupled to the attachment fixtures.

In one embodiment, the universal attachment structure is collapsible. A base section includes hinges for folding inward. The one or more wheels affixed to the base section also fold inward. The telescoping arms have a bottom section and a top section, the top section capable of collapsing towards the bottom section. Attachment fixtures include hinges for folding inward. A handle is capable of collapsing into the attachment fixtures. The handle may collapse into the attachment fixtures either from a vertical distance or from a horizontal distance. Alternatively, the base and the attachment fixtures may include hinges for folding upward and downward, respectively.

A further understanding of the nature and advantages of the inventions herein may be realized by reference to the remaining portions of the specification and the attached drawings.

### BRIEF DESCRIPTION OF THE DRAWINGS

FIG. 1 is an exemplary universal attachment structure in accordance with an embodiment of the present invention;

FIG. 2 is a handle and rear adjustable loop portion of the universal attachment structure in accordance with an embodiment of the present invention;

FIG. 3 is a hinged handle in accordance with an embodiment of the present invention;

FIG. 4 is a base in accordance with an embodiment of the present invention;

FIG. 5 is an alternative embodiment of the base;

FIG. 6 is a telescoping handle in accordance with an embodiment of the present invention;

FIG. 7 is a collapsible universal attachment structure in accordance with an embodiment of the present invention; and

FIG. 8 is a slidable base and base strap in accordance with an embodiment of the present invention.

### DESCRIPTION OF THE EXEMPLARY EMBODIMENTS

As shown in the exemplary drawings wherein like reference numerals indicate like or corresponding elements among the figures, an embodiment of a system according to the present invention will now be described in detail. The following description sets forth an example of a universal attachment structure.

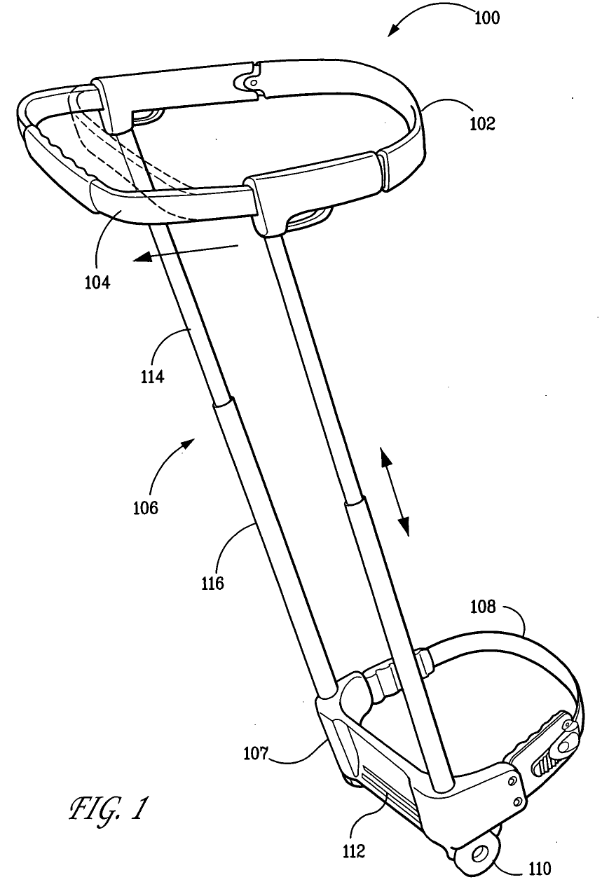

Referring now to FIG. 1, an exemplary universal attachment structure 100 in accordance with the present invention is shown. The universal attachment structure 100 includes a rear adjustable loop 102, a handle 104, telescoping arms 106, a base 107, a base strap 108, and wheels 110 coupled to opposite sides of the base 107. Any type of wheels 110 may be employed in accordance with the present invention. For example, inline skate wheels may be utilized. Optionally, the universal attachment structure 100 may provide a kick plate 112.

Ideally, the rear adjustable loop 102 can be adjusted to fit any item, such as a golf bag. A top of the item, such as the golf bag, is supported by and surrounded by the rear adjustable loop 102. The rear adjustable loop 102 may create tension around the top perimeter of the golf bag, such that the top of the golf bag remains in place without need for a force applied towards the front side of the golf bag. Although the universal attachment structure 100 is advantageous for transporting a golf bag, any item may be attached to and transported via the universal attachment structure 100.

The rear adjustable loop 102, base strap 108, and wheels 110 may be attached to the universal attachment structure 100 in any manner consistent with the present invention, such as by fasteners, sewing, bolts, etc. The rear adjustable loop 102 may be made of plastic, rubber, etc. Any material suitable for use with the present invention may be employed.

Preferably, the handle 104 is extendable from the universal attachment structure 100. In one embodiment, the extension may occur outwardly, away from the universal attachment structure 100 in a generally horizontal direction. Alternatively, the extension may occur outwardly and away from the universal attachment structure 100 in a generally horizontal direction, as well as upwardly and away from the universal attachment structure 100 in a generally vertical direction. Extending the handle 104 in the horizontal direction provides added space for the golf bag and may allow for room between the golf bag and the universal attachment structure 100 for grasping the handle 104.

The rear adjustable loop 102 and the base 107 provide stability to the golf bag. Thus, extending the handle 104 typically does not result in the golf bag falling against the handle 104. Instead, the golf bag remains stationary. However, as is discussed herein, another adjustable loop near the handle 104 may be included to further secure the golf bag.

The telescoping arms 106 include top sections 114 and bottom sections 116. Typically, each bottom section 116 acts as a receptacle for the top sections 114. However, the top sections 114 may slide over the bottom sections 116, in which case the top sections 114 would be the larger of the two sections and would envelope the bottom sections 116. When the telescoping arms 106 are extended, the top section 114 and the bottom section 116 slide along their respective lengths.

At the bottom of the universal attachment structure 100 is the base 107. Coupled to the base 107 is a base strap 108. The base strap 108 holds a bottom portion of the golf bag in place. Typically, the golf bag is placed within the base strap 108; the base strap 108 is tightened around the golf bag. In an alternate embodiment, the universal attachment structure 100 includes a floor or platform contiguous with the base 107 on which to rest the golf bag. In yet another embodiment, a base piece having side walls may be included as part of the universal attachment structure 100, so that a user can slide a golf bag into the base piece, the side walls of which help secure the bottom of the golf bag.

The base strap 108 may be made of any material that is suitable for use with the present invention, such as plastic, leather, etc. Further, any means of securing the golf bag to the universal attachment structure 100 with the base strap 108 may be utilized, such as a buckle. FIG. 1, for example, shows a ratcheting construction for securing the golf bag to the universal attachment structure 100 with the base strap 108. Once the golf bag is strapped to, or otherwise attached to, the universal attachment structure 100, the golf bag can be transported to and from the golf course, on the golf course, etc.

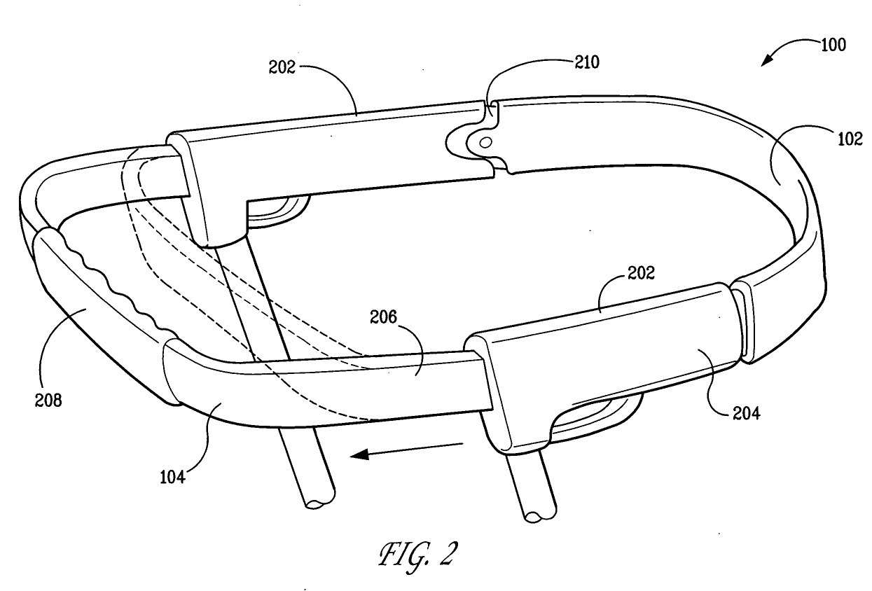

Referring now to FIG. 2, the handle 104 and rear adjustable loop 102 of the universal attachment structure 100 is shown. Attachment fixtures 202 create structures to which the rear adjustable loop 102, the handle 104, and the telescoping arms 106 can attach. In essence, the attachment fixtures 202 attach the rear adjustable loop 102 and the handle 104 to the telescoping arms 106. The attachment fixtures 202 may include a logo 204 of some type in accordance with an embodiment of the present invention. The attachment fixtures 202 may be made of metal, plastic, or any other materials suitable for use with the present invention.

In one embodiment, the attachment fixtures 202 may be covered with a fabric (not shown), such as felt, terry cloth, chamois, etc. for preventing friction with an item attached to the universal attachment structure 100, such as a golf bag. The fabric may also help to limit the movement of the golf bag. Further, the fabric may be useful in preventing scratches to golf paraphernalia, golf club shafts, etc. in the event that such items come into contact with the attachment fixtures 202. Any fabric suitable for use with the present invention may be employed.

In the present embodiment, the handle 104 includes two rigid sections 206 and a shock absorbent section 208. The two rigid sections 206 are on either side of the shock absorbent section 208. However, as many or as few sections may comprise the handle 104 as is suitable with the present invention. The rigid sections 206 may be comprised of a metal, plastic, etc. The shock absorbent section 208 may be made of rubber, plastic, fabric, etc. Generally, the shock absorbent section 208 is affixed to the rigid section 206 in some manner. However, the rigid sections 206 and the shock absorbent section 208 may be independent contiguous sections.

Typically, the shock absorbent section 208 is the area grasped by a user in order to engage the handle 104 and move the universal attachment structure 100 and any item attached to the universal attachment structure 100. In one embodiment, the shock absorbent section 208 is a removable piece of fabric. In such an embodiment, the shock absorbent section 208 may be removed in order to be cleaned, replaced, etc. The removable shock absorbent section 208 may be attached to the rigid section 206 by velcro, buttons, snaps, or any other suitable method of attachment.

In the present embodiment, the rear adjustable loop 102 includes a coupling mechanism 210 on either end of the rear adjustable loop 102 for coupling the rear adjustable loop 102 to the attachment fixtures 202. On one end of the universal attachment structure 100, the coupling mechanism 210 is permanently affixed to the attachment piece 202. On a second end of the universal attachment structure 100, the coupling mechanism 210 is removably affixed to the attachment piece 202. In other words, in order for the rear adjustable loop 102 to effectively hold the golf bag in place and provide a convenient manner of attaching the top of the golf bag to the universal attachment structure 100, the rear adjustable loop 102 is detachable from the attachment piece 202 on one end, but remains attached to the attachment piece 202 on the other end. Alternatively, both ends of the rear adjustable loop 102 may be detachable from the universal attachment structure 100 via the coupling mechanisms 210.

The coupling mechanism 210 that allows for detachability of the rear adjustable loop 102 may be any type of adhesive, velcro, snap, ratchet system, buckle, etc. For example, a ring and hook system may be employed for coupling the rear adjustable loop 102 to the attachment fixtures 202. The coupling mechanism 210 that permanently affixes the rear adjustable loop 102 to the universal attachment structure 100 may be a bolt, welding, or any other suitable means for affixing the rear adjustable loop 102 to the attachment piece 202.

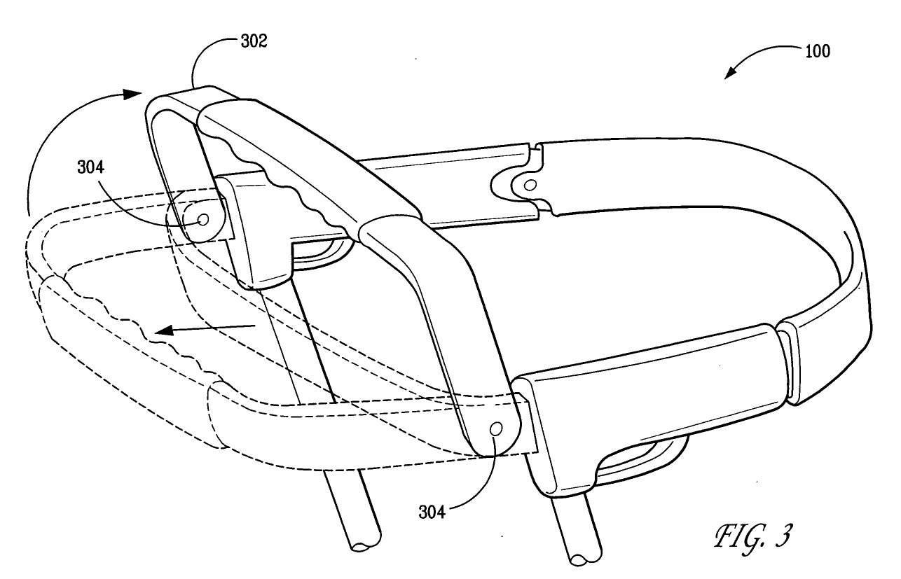

Referring now to FIG. 3, a hinged handle 302 in accordance with an embodiment of the present invention is shown. In this particular embodiment, the handle 302 may include an attachment fixture hinge 304 on each end of the handle 302. By utilizing the attachment fixture hinge 304, the handle 302 may be maneuvered in an upwardly direction. Accordingly, a user can pull the handle 302 outwardly and upwardly in order to transport an item attached to the universal attachment structure 100. Any type of attachment fixture hinge 304 suitable for use with the present invention may be employed. For example, a spring-loaded hinge, an “h” hinge, a double action hinge, pivot hinge, etc. may be utilized.

In order to maintain a particular position of the handle 302, the attachment fixture hinge 304 may be lockable. The user can lock the attachment fixture hinge 304 in any position the user desires. Thus, the handle 302 can be maintained in a 90 degree position, a 45 degree position, and so forth. In one embodiment, the handle 302 may be hinged at two points near either end of the handle 302. Thus, the user can lock a first section of the handle 302 in a first position and lock a second section of the handle 302 in a seconds position.

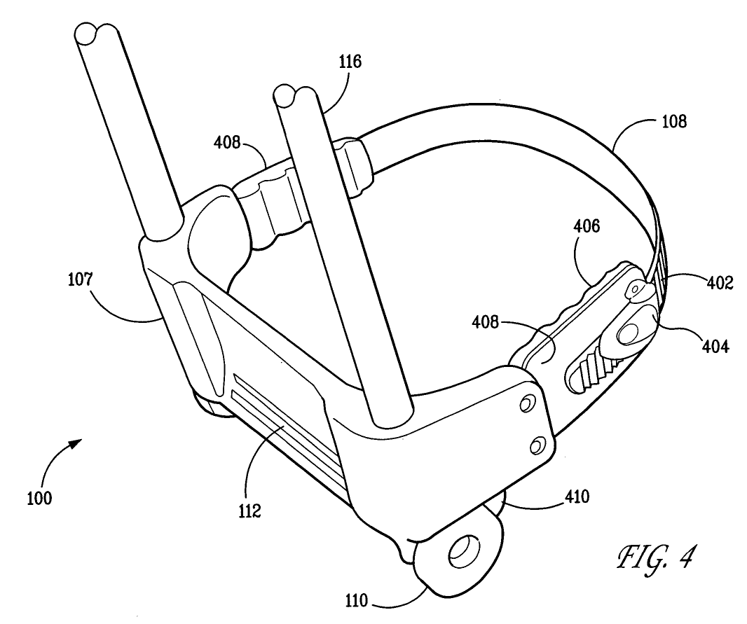

Referring now to FIG. 4, a base 107 in accordance with the FIG. 1 embodiment of the present invention is shown. The base 107 supports the bottom sections 116 of the telescoping arms 106 (FIG. 1). The base 107 shown in FIG. 4 includes a curvature on either side for receiving the base strap 108. However, any shape of the base 107 suitable for use with the present invention may be employed. As discussed herein, the base 107 may include a kickplate 112 area.

The base strap 108 shown in FIG. 4 includes ratchets 402 for ratcheting the base strap 108 to a fastening mechanism 404 coupled to one of two extension pieces 408 coupled to the base 107. The fastening mechanism 404 fastens the base strap 108 to the extension piece 408 of the base 107 and helps secure an item to the universal attachment structure 100. Any type of fastening mechanism 404 may be utilized in accordance with the invention.

An inner portion of the base 107 includes gripping portions 406. The gripping portions 406, in connection with the base strap 108, maintain the golf bag in place. In one embodiment, gripping portions 406 are also coupled to the attachment fixtures 202 to maintain the top of the golf bag in place. In this embodiment, the gripping portions coupled to the attachment fixtures 202 help to prevent the golf bag from moving in a direction opposite the rear adjustable loop 102.

In FIG. 4, the fastening mechanism 404 is capable of locking the base strap 108 to the extension piece 408 by applying tension to the ratchets 402. However, the fastening mechanism 404 may be a buckle, the base strap 108 being a material capable of being buckled to the fastening mechanism 404, for example. Other forms of fastening mechanisms 404 are also contemplated for use in the present invention.

The extension piece 408 may be affixed to the base 107 in any manner consistent with the present invention, including, but not limited to, welding, nut and bolt, and manufacturer's glue. Further, the base strap 108, itself, may be coupled to the base 107 without use of extension pieces 408. As shown in FIG. 4, the wheels 110 are coupled to the base 107. A recessed area 410 on either end of the base 107 creates a niche for the wheels 110.

In one embodiment, the base strap 108 is directly coupled to the bottom sections 116 of the telescoping arms 106. In this embodiment, the base strap 108 is capable of being moved along the telescoping arms 106 in order to strap a golf bag onto the universal attachment structure 100 at any location along the golf bag's vertical axis. Further, a floor of the base 107 may be included in order to lend support to the golf bag, but the floor of the base 107 is not required.

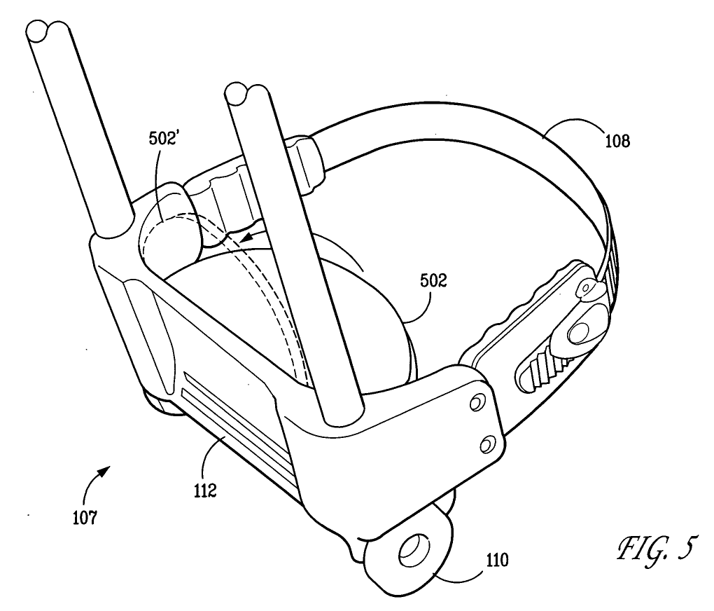

Referring now to FIG. 5, an alternative embodiment of the base 107 is shown in accordance with the invention. In this embodiment, the base 107 includes a flange 502 extending from the base 107, on which to rest a golf bag. The flange 502 may be made of any material suitable for use with the present invention. For example, the flange 502 may be made of plastic, a lightweight metal, etc. The flange 502 may extend as far or as near the base 107 as desired according to the present invention. Although the flange 502 in FIG. 5 is curved, the flange may be any shape according to the present invention. For example, the flange 502 may be rectangular in shape.

In one embodiment, the flange 502 is capable of folding up towards the base 107. In this embodiment, the flange 502 is hinged at a point of coupling to the base 107. Alternatively, the flange 502, itself, may include a hinged area, allowing it to fold toward the base 107.

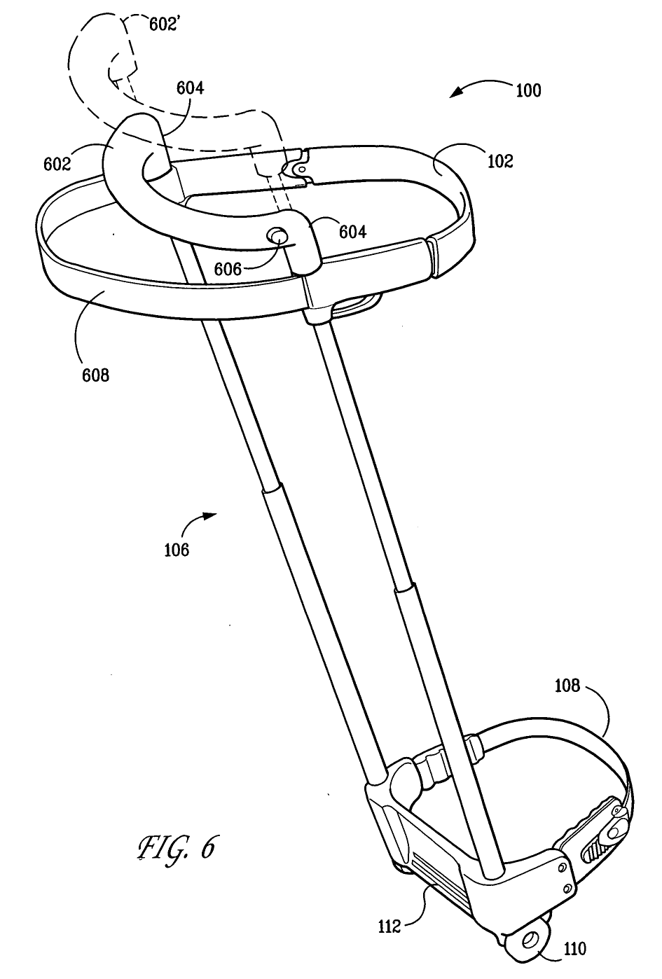

Referring now to FIG. 6, a telescoping handle in accordance with one embodiment of the present invention is shown. The telescoping handle 602 is affixed to two telescoping supports 604. The telescoping supports 604 extend from the telescoping arms 106 (FIG. 1) in this embodiment. The user can pull the telescoping handle 602 in an upwardly direction in order to engage the telescoping supports 604, and transport the item attached to the universal attachment structure 100 by pushing or pulling the universal attachment structure 100. A release button 606 may be included on the telescoping handle 602 in one embodiment, for locking the telescoping handle 602 into a resting position and an extended position. Alternatively, the release button 606 may be located elsewhere on the universal attachment structure 100.

The telescoping handle 602 shown in FIG. 6 is crescent shaped. The crescent shape is advantageous with respect to the telescoping handle 602 because it provides stability when transporting an item attached to the universal attachment structure 100 since the center of gravity is directed towards the user pulling the universal attachment structure 100. However, any shape of the telescoping handle 602 is within the scope of the invention. For instance, the telescoping handle 602 may be straight, hexagonal, etc.

In this embodiment, a front adjustable loop 608 may be included for securing the item to the universal attachment structure 100. Although the rear adjustable loop 102 on a back side of the universal attachment structure 100 secures one side of the item to the universal attachment structure 100, it may be beneficial to secure an opposing side of the item utilizing the front adjustable loop 608.

The front adjustable loop 608 may be made of any material. For instance, the front adjustable loop 608 may be made of rubber, plastic, leather, etc. Further, the front adjustable loop 608 may be coupled to the attachment fixtures 202 (FIG. 2) of the universal attachment structure 100 in any manner consistent with the present invention, such as via snaps, buckles, welding, etc. The front adjustable loop 608 may permanently attach to the attachment fixtures 202 at both ends or at one end. Any combination of attachment methods is also within the scope of the invention. In one embodiment, a single rear adjustable loop 102 surrounds the item attached to the universal attachment structure 100, rather than a separate rear adjustable loop 102 on the back side and front adjustable loop 608 on a front side being utilized to independently secure the golf bag to the universal attachment structure 100.

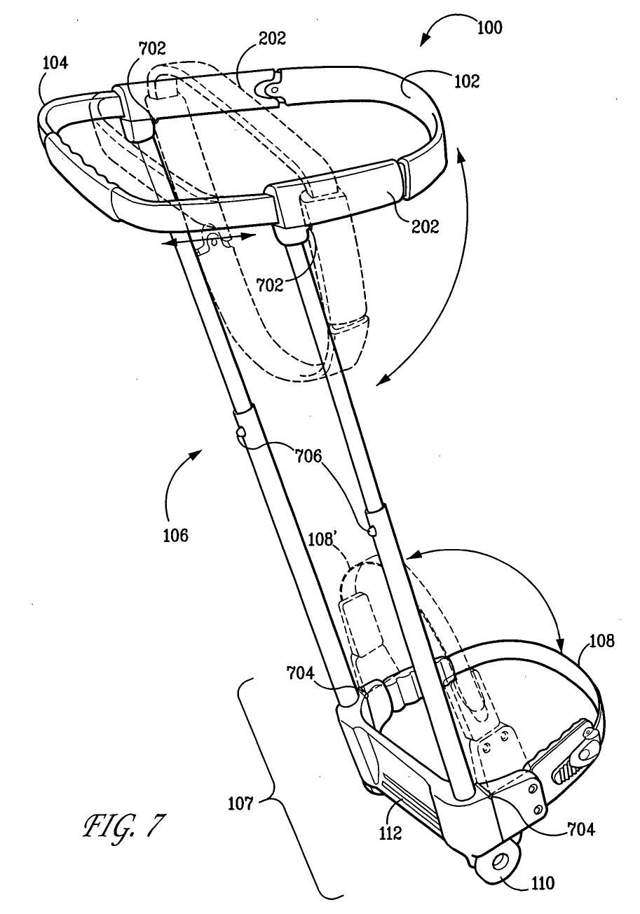

Referring now to FIG. 7, an embodiment showing a collapsible universal attachment structure 100 is shown. In the FIG. 7 embodiment, each attachment fixture 202 includes attachment fixture hinges 702, and the base 107 includes base hinges 704. Any type of attachment fixture hinges 702 and base hinges 704 are within the scope of the invention. The attachment fixture hinges 702 may be located horizontally or vertically along the attachment fixtures 202. Horizontal attachment fixture hinges 702 allow the attachment fixtures 202, as well as a rear adjustable loop 102, extendable handle 104, telescoping handle 602, and/or front support loop 608 attached thereto, to fold downward. Vertical attachment fixture hinges 702 allow the attachment fixtures 202 and any structures integral to the universal attachment structure 100 to fold inward.

Similarly, the base hinges 704 (FIG. 1) may be located in a horizontal or vertical position. Horizontal base hinges 704 allow the base 107 and any wheels 110, base strap 108, base floor, platform, flange, etc. attached thereto to be folded upward. Vertical base hinges 704 allow the base 107 and any wheels 110 and/or base strap 108 attached thereto, to be folded inward.

By folding the attachment fixtures 202 and the base 107 inward, or upward and downward, depending upon the location of the hinges, the universal attachment structure 100 is collapsed. The telescoping arms 106 can also be collapsed by receding the top section 114 into the bottom section 116. One or more of the telescoping arms 106 may include an adjustment button 706 for changing the height of the universal attachment structure 100 and/or for collapsing the top section 114 into the bottom section 116. A handle 104 may be coupled to the attachment fixtures 202 either from a horizontal or vertical distance. In other words, the handle 104 may extend from and/or recede into the attachment fixtures 202 vertically or horizontally. Accordingly, the user can easily transport the universal attachment structure 100, which adds minimal bulk and minimal weight to the golf bag attached thereto.

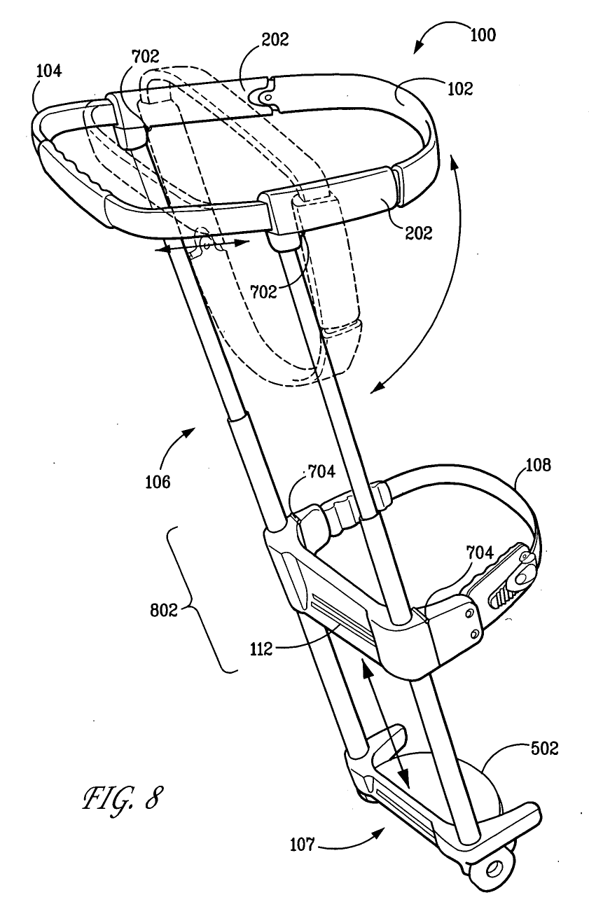

Referring now to FIG. 8, a slidable base strap section 802 is shown in accordance with an embodiment of the present invention. The slidable base strap section 802 can move vertically along the telescoping arms 106. The base 107 and flange 502 may remain in place for receipt of an item. The slidable base strap section 802 can be moved to any location along the telescoping arms 106 to secure the item at a particular location along the item's vertical axis. In one embodiment, the slidable base strap section 802 includes a locking mechanism for securing the position of the slidable base strap section 802 at a particular location along the telescoping arms 106. Although base hinges 704 and attachment fixture hinges 702 are shown, the universal attachment structure 100 may or may not include base hinges 704 or attachment fixture hinges 702, as discussed herein. Further, any type of handle 104 may be utilized.

Generally, the universal attachment structure 100 is made of lightweight, yet durable materials. Thus, the user can attach a golf bag, for example, without adding considerable weight to the golf bag, itself. Accordingly, the user can readily transport the golf bag via the universal attachment structure 100 or lift the golf bag and universal attachment structure 100 for manual transportation thereof should the user desire.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1. A universal attachment structure, comprising:
a base section;
one or more wheels coupled to the base section;
one or more telescoping arms extending upward from the base section;
at least one adjustable loop coupled to the telescoping arms; and
a handle coupled to the at least one adjustable loop.

2. The universal attachment structure of claim 1, wherein the base section further comprises a securing mechanism for securing an item to the base section.

3. The universal attachment structure of claim 2, wherein the securing mechanism includes at least one ratchet.

4. The universal attachment structure of claim 2, wherein the securing mechanism is an adjustable strap.

5. The universal attachment structure of claim 4, wherein the adjustable strap includes at least one ratchet.

6. The universal attachment structure of claim 1, wherein the base section further comprises a kickplate.

7. The universal attachment structure of claim 1, wherein the one or more wheels coupled to the base section are inline skate wheels.

8. The universal attachment structure of claim 1, wherein the at least one adjustable loop is coupled to the telescoping arms via attachment fixtures.

9. The universal attachment structure of claim 8, wherein the at least one adjustable loop comprises a first end and a second end.

10. The universal attachment structure of claim 8, wherein the base section and the attachment fixtures further comprise hinges.

11. The universal attachment structure of claim 8, wherein the first end of the at least one adjustable loop is permanently coupled to the attachment fixtures.

12. The universal attachment structure of claim 8, wherein the second end of the at least one adjustable loop is detachably coupled to the attachment fixtures.

13. The universal attachment structure of claim 1, wherein the handle is extendable.

14. The universal attachment structure of claim 1, wherein the handle further comprises hinges.

15. The universal attachment structure of claim 1, wherein the handle further comprises a shock absorbent section.

16. The universal attachment structure of claim 1, further comprising telescoping supports coupled to the telescoping arms.

17. The universal attachment structure of claim 16, wherein the handle is coupled to the telescoping supports.

18. The universal attachment structure of claim 1, further comprising a flange section coupled to the base section for providing additional support.

19. A collapsible universal attachment structure, comprising:
a hinged base;
one or more wheels coupled to the base;
an adjustable strap coupled to the base;
telescoping arms having a top section and a bottom section extending upwardly from the base;
at least two hinged attachment fixtures for receiving the top section of the telescoping arms; and
an extendable handle coupled to the attachment fixtures.

20. The universal attachment structure of claim 19, wherein the extendable handle is coupled to a vertical end of the at least two hinged attachment fixtures.

21. The universal attachment structure of claim 19, wherein the extendable handle is coupled to a horizontal end of the at least two hinged attachment fixtures.

22. The universal attachment structure of claim 19, wherein the adjustable strap is capable of sliding vertically along the telescoping arms.

23. The universal attachment structure of claim 19, further comprising an adjustable loop coupled to the at least two hinged attachment fixtures.

24. The universal attachment structure of claim 19, further comprising an adjustable loop coupled to the top section of the telescoping arms.

25. The universal attachment structure of claim 24, wherein the adjustable loop is capable of sliding along a length of the telescoping arms.

26. The universal attachment structure of claim 19, further comprising a hinged platform coupled to the base section for providing additional support.

27. The universal attachment structure of claim 26, wherein the platform is a flange.

28. The universal attachment structure of claim 19, wherein the bottom section of the telescoping arms is configured to receive the top section of the telescoping arms.
